(19) United States
(12) Patent Application Publication
(10) Pub. No.: US 2004/0243579 A1
(43) Pub. Date: Dec. 2, 2004

(54) Method for accessing personal medical image data

(76) Inventors: Thomas Birkhoelzer, Radolfzell (DE); Frank Krickhahn, Herzogenaurach (DE); Juergen Vaupel, Weisendorf (DE)

Correspondence Address: HARNESS, DICKEY & PIERCE, P.L.C., P.O.BOX 8910, RESTON, VA, 20195, US

(21) Appl. No.: 10/348,018

(22) Filed: Jan. 22, 2003

(30) Foreign Application Priority Data
Jan. 22, 2002 (DE) 10202283.6

(51) Int. Cl. G06F 17/30

(52) U.S. Cl. 707/9

(57) ABSTRACT

A cache portal of a database system receives an access request from an application for access to personal medical image data stored in the database system. The access request is directed as such only to the database system. The cache portal automatically determines a database of the database system in which the image data are stored, and forwards the access request to the database determined. It receives the image data from the database determined and communicates the data to the application.

The present application hereby claims priority under 35 U.S.C. §119 on German patent application number DE 10202283.6 filed Jan. 22, 2002, the entire contents of which are hereby incorporated herein by reference.

### FIELD OF THE INVENTION

The present invention generally relates to a method for accessing personal medical image data stored in a database system. Preferably it relates to one wherein the database system receives an access request from an application for access to the personal medical image data. This access request is preferably directed to the database system, and the personal medical data is preferably communicated from the database system to the application.

### BACKGROUND OF THE INVENTION

Applications at medical workstations often require access to digital personal medical image data. However, the image data are often stored at different locations of a database system e.g. in a local database in a database of another system (e.g. a server) or in different image archives (e.g. archives of different departments or evolved structures).

In order to be able to find and use the required image data, in the prior art, the data topology has to be known to the application. It thus has to know which database of the database system image data are stored in. The data topography thus has to be impressed on each application. This is highly laborious, particularly in the case of many applications and changes in the data topology, since each application has to be changed correspondingly.

### SUMMARY OF THE INVENTION

An object of an embodiment of the present invention is to provide a database system whose topography no longer has to be known to the application.

An object may be achieved by an embodiment including the following features:

a cache portal of the database system receiving an access request from an application for access to the personal medical image data, which access request is directed as such only to the database system,

the cache portal automatically determining a database of the database system in which the personal medical image data are stored,

the cache portal forwarding the access request to the database determined,

the cache portal receiving the personal medical data from the database determined and communicating said data to the application.

If the communication between the cache portal and the database determined is effected in accordance with the DICOM protocol, it is possible to have recourse to proven standard methods for implementation of the communication.

If the cache portal stores the personal medical image data after receiving the latter from the database determined, a time-staggered communication between the cache portal and the database on the one hand, and between the cache portal the application on the other hand, is possible.

If the cache portal performs the forwarding of the access request and the reception of the personal medical image data only when the personal medical image data are not stored in the cache portal, or when they are not presently stored, image data that have already been requested beforehand—possibly by another application—can be communicated more rapidly to the application.

### BRIEF DESCRIPTION OF THE DRAWINGS

Further advantages and details emerge from the following description of an exemplary embodiment. In this case, in a basic illustration,

FIG. 1 shows a database system with a cache portal and

FIG. 2 shows a flow diagram.

### DETAILED DESCRIPTION OF THE PREFERRED EMBODIMENTS

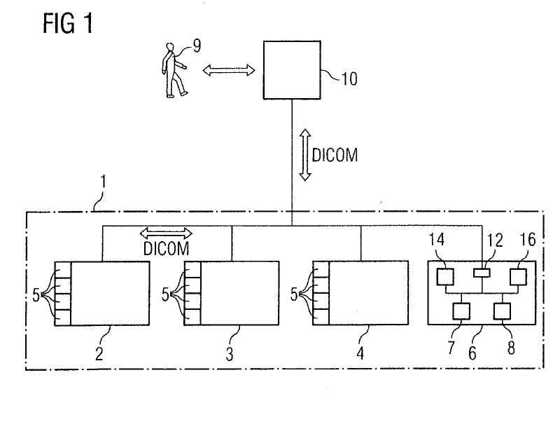

In accordance with FIG. 1, a database system 1 has a plurality of databases 2 to 4. Personal medical image data 5 are stored in digital form in the databases 2 to 4. The database system 1 furthermore has a cache portal 6. The cache portal 6 has a main unit 7. The method of operation of the main unit 7 is controlled by a computer program product 8.

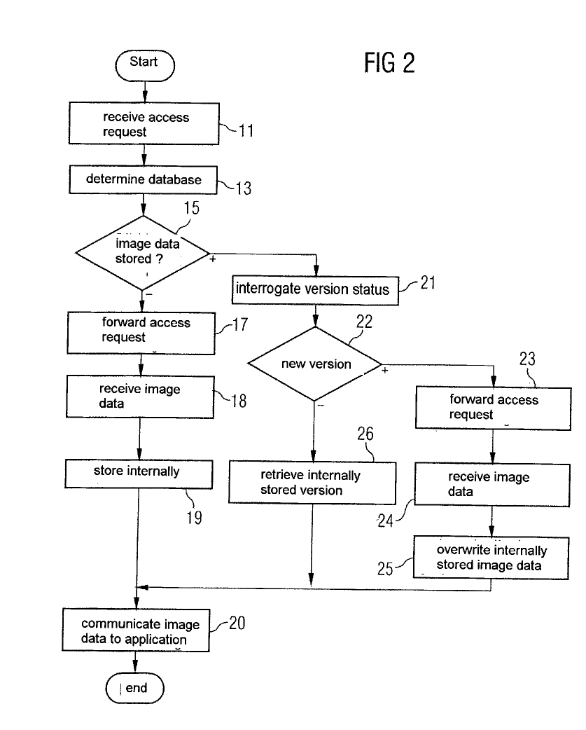

If image data 5 are intended to be retrieved from one of the databases 2 to 4 by a user 9 via an application 10, this is done in the manner described below in conjunction with FIG. 2. In this case, FIG. 2 shows the control of the main unit 7 of the cache portal 6 by the computer program product 8.

If an access request for access to the personal medical image data 5, which access request is directed as such only to the database system 1, is communicated to the database system 1, the cache portal 6 receives the access request via an interface 12 in a step 11. Then, in a step 13, using structure data, the cache portal 6 automatically determines a database 2 to 4 in which the requested image data 5 are stored. In this case, the structure data are stored in a structure data memory 14 of the cache portal 6. Then, in a step 15, the cache portal 6 checks whether the requested image data are already buffer-stored in a buffer memory 16 of the cache portal 6.

If the image data 5 are not buffer-stored in the buffer memory 16, in a step 17 the access request is forwarded to the database 2 to 4 determined. The database 2 to 4 thereupon communicates the requested image data 5 to the cache portal 6, which receives the data in a step 18 and buffer-stores them internally in a step 19. Then, in a step 20, the cache portal 6 communicates the requested personal medical image data 5 to the application 10.

In this case, as is indicated in FIG. 1, the communication between the cache portal 6 and the data bases 2 to 4 is effected e.g. in accordance with the DICOM protocol. The communication between the cache portal 6 and the application 10 is also effected e.g. in accordance with the DICOM protocol.

If the image data 5 are already stored in the buffer memory 16, in step 15 the procedure branches to a step 21. In step 21, the cache portal 6 communicates an interrogation with regard to the version status to the database 2 to 4 determined. In a step 22, it then compares the communicated version status with the version status of the corresponding image data 5 already stored in the buffer memory 16.

If the comparison reveals that the image data 5 stored in the database 2 to 4 determined have a more up to date version status than the image data 5 stored in the buffer memory 16, in accordance with a step 23 the access request is forwarded again to the database 2 to 4 determined. In a step 24, the image data 5 communicated by the database 2 to 4 determined are then received again by the cache portal 6. In a step 25, these image data 5 overwrite the corresponding older image data 5 previously stored in the buffer memory 16. The procedure then jumps to step 20, in which the image data 5 are communicated to the application 10.

If the image data 5 are stored in the buffer memory 16 and a more up to date version of the image data 5 is not stored in the database 2 to 4 determined, a step 26 is executed. In this step, the image data 5 stored internally in the buffer memory 16 are retrieved. The procedure then branches to step 20 again, that is say that the image data 5 retrieved from the buffer memory 16 are communicated to the application 10. The forwarding of the access request and the reception of the personal medical image data 5 are thus performed by the cache portal 6 only when the personal medical image data 5 are not stored, or are not presently stored, in the cache portal 6.

As a result, the organization of the database system 1 has the effect that the topology of the database system 1 no longer has to be known to the application 10. Rather, accesses to the databases 2 to 4 are effected transparently.

### List of Reference Symbols

1 database system

2-4 databases

5 image data

6 cache portal

7 main unit

8 computer program product

9 user

10 application

11, 13, 15 steps

12 interface

14, 16 memories

17-26 steps

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for accessing personal medical image data stored in a database system, comprising:
receiving an access request in a cache portal of the database system, from an application for access to the personal medical image data, the access request being directed only to the database system;
automatically determining in the cache portal, a database of the database system in which the personal medical image data are stored;
forwarding the access request from the cache portal to the database determined;
receiving, in the cache portal, the personal medical image data from the database determined; and
communicating the received data to the application.

2. The access method as claimed in claim 1, wherein communication between the cache portal and the database determined is effected in accordance with the DICOM protocol.

3. The access method as claimed in claim 1, wherein the cache portal stores the personal medical image data after receiving the personal medical image data from the database determined.

4. The access method as claimed in claim 3, wherein the cache portal performs the forwarding of the access request and the reception of the personal medical image data only when at least one of,
the personal medical image data are not stored in the cache portal, and
the personal medical image data are not presently stored in the cache portal.

5. A computer program product for carrying out the access method as claimed in claim 1.

6. A cache portal programmed with a computer program product as claimed in claim 5.

7. The access method as claimed in claim 2, wherein the cache portal stores the personal medical image data after receiving the personal medical image data from the database determined.

8. The access method as claimed in claim 7, wherein the cache portal performs the forwarding of the access request and the reception of the personal medical image data only when at least one of,
the personal medical image data are not stored in the cache portal, and
the personal medical image data are not presently stored in the cache portal.

9. A computer program product for carrying out the access method as claimed in claim 2.

10. A cache portal programmed with a computer program product as claimed in claim 9.

11. A computer program product for carrying out the access method as claimed in claim 3.

12. A cache portal programmed with a computer program product as claimed in claim 11.

13. A computer program product for carrying out the access method as claimed in claim 4.

14. A cache portal programmed with a computer program product as claimed in claim 13.

15. A cache portal for use in conjunction with a database system storing personal medical image data, comprising:
means for receiving an access request from an application for access to the personal medical image data, the access request being directed only to the database system;
means for automatically determining a database of the database system in which the personal medical image data are stored;
means for forwarding the access request to the database determined;
means for receiving the personal medical image data from the database determined; and
means for communicating the received data to the application.

16. The cache portal as claimed in claim 15, wherein communication between the cache portal and the database determined is effected in accordance with the DICOM protocol.

17. The cache portal as claimed in claim 15, further comprising:
means for storing the personal medical image data after receiving the personal medical image data from the database determined.

18. The cache portal as claimed in claim 17, wherein the means for forwarding forwards the access request and the means for receiving receives the personal medical image data only when at least one of,
the personal medical image data are not stored in the cache portal, and
the personal medical image data are not presently stored in the cache portal.

19. A method of operation of a cache portal for use in conjunction with a database system storing personal medical image data, comprising the steps of:
receiving an access request from an application for access to the personal medical image data, the access request being directed only to the database system;
automatically determining a database of the database system in which the personal medical image data are stored;
forwarding the access request to the database determined;
receiving the personal medical image data from the database determined; and
communicating the received data to the application.

20. The method as claimed in claim 19, wherein communication between the cache portal and the database determined is effected in accordance with the DICOM protocol.

21. The method as claimed in claim 19, wherein the cache portal stores the personal medical image data after receiving the personal medical image data from the database determined.

22. The method as claimed in claim 21, wherein the cache portal performs the forwarding of the access request and the reception of the personal medical image data only when at least one of,
the personal medical image data are not stored in the cache portal, and
the personal medical image data are not presently stored in the cache portal.

23. A computer program product for carrying out the method as claimed in claim 19.

24. A cache portal programmed with a computer program product as claimed in claim 23.
